(19) United States
(12) Patent Application Publication
(10) Pub. No.: US 2007/0182058 A1
(43) Pub. Date: Aug. 9, 2007

(54) Process for preparing vegetable casing and transferring apparatus used therein

(75) Inventors: Wen-Lian Chen, Hsinchu (TW); Sam-Long Hwang, Hsinchu (TW); Bao-Hung Huang, Hsinchu (TW); Lin-Shyang Tzeng, Hsinchu (TW); Shih-Jung Liu, Taipei (TW); Chia-Yuan Tsai, Hsinchu (TW)

Correspondence Address: BACON & THOMAS, PLLC, 625 SLATERS LANE, FOURTH FLOOR, ALEXANDRIA, VA, 22314, US

(73) Assignee: Food Industry Research and Development Institute, Hsinchu (TW)

(21) Appl. No.: 11/388,005

(22) Filed: Mar. 24, 2006

(30) Foreign Application Priority Data
Feb. 3, 2006 (TW) 95103781

(51) Int. Cl. B29C 47/00; A23G 3/02

(52) U.S. Cl. 264/211.11; 264/211.12; 426/284; 426/512; 426/514; 425/326.1

(57) ABSTRACT

The present invention discloses an extrusion process for preparing vegetable casing including preparing a continuous tubular extrudate by extrusion, and transferring the continuous tubular extrudate. The transferring includes repeatedly passing a plurality of separate horizontal posts below the continuous tubular extrudate, hanging the continuous tubular extrudate on the posts so that the continuous tubular extrudate is conveyed by the posts a distance, while a closed space is formed inside the tubular extrudate and between every two adjacent horizontal posts.

### FIELD OF THE INVENTION

The present invention relates to a process for producing an edible proteinaceous casing and a transferring apparatus for use in the process for producing an edible proteinaceous casing.

### BACKGROUND OF THE INVENTION

U.S. Pat. No. 5,569,482 discloses a process for producing an edible proteinaceous film entails kneading and melting a raw material containing water and protein with heating by an extruder, extruding the melted material through a die in an extruder to form a tubular extrudate, providing a gas at a pressure above atmospheric pressure to the interior of the tubular extrudate while exhausting the gas, and holding and receiving the tubular extrudate with a take-off means, wherein the tubular extrudate forms a closed space therein and between the circular opening of the die and the holding type take-off means to prevent the inner walls of the tubular extrudate from adhering. An apparatus for use with the method is also disclosed. In this prior art process the tubular extrudate is not sufficiently cooled prior to the take-off means, because the distance between the die and the take-off means is limited, so that an anit-blocking agent is added and entrained in the gas injected into the interior of the tubular extrudate to prevent the inner walls of the tubular extrudate from adhering. The anti-blocking agent used is starch particles having particle size of 5-50 μm, which may be in the form of microcapsules with edible fats and oils, etc. Further, the extruding rate is also limited by this insufficient cooling, i.e. the production rate is limited. The disclosure of U.S. Pat. No. 5,569,482 is incorporated herein by reference.

### SUMMARY OF THE INVENTION

A primary objective of the present invention is to provide a process for preparing vegetable casing without the drawbacks of the prior art.

In order to accomplish the objective, a technique for preparing vegetable casing provided by the present invention transfers the continuous tubular extrudate in the hanging manner, creating a relatively much longer cooling distance (time) before the continuous tubular extrudate is clamped by a take-off means, so that an anti-blocking agent may be avoided in the process of the present invention and the production rate of the present process may be increased.

### BRIEF DESCRIPTION OF THE DRAWINGS

FIG. 1 is a schematic diagram showing an example of the apparatus for producing the edible vegetable film of the present invention including an extruder and circumferential devices.

FIG. 2 is a partial enlarged cross section of the main part in FIG. 1 wherein the die is attached to the front end of the barrel of the extruder.

FIG. 3 is a schematic view showing a transferring apparatus of the preset invention suitable for use in FIG. 1.

### DETAILED DESCRIPTION OF THE PREFERRED EMBODIMENTS

The present invention discloses a process for preparing vegetable casing comprising the following steps:

a) extruding a continuous tubular extrudate; and

b) transferring the continuous tubular extrudate;

characterized in that said transferring comprises repeatedly and horizontally moving a plurality of spaced horizontal posts at a constant speed below the continuous tubular extrudate; hanging the continuous tubular extrudate on the plurality of horizontal posts to transfer the continuous tubular extrudate a distance, wherein a closed space is formed in the continuous tubular extrudate hanged between two adjacent horizontal posts.

Preferably, the plurality of horizontal posts are moved at a speed equal to or lower than the extruding speed of the continuous tubular extrudate.

Preferably, the plurality of horizontal posts are spaced at a constant interval.

Preferably, the process of the present invention further comprises cutting the continuous tubular extrudate into a continuous film after said continuous tubular extrudate being transferred a distance.

Preferably, the process of the present invention further comprises collecting the continuous tubular extrudate after said continuous tubular extrudate being transferred a distance.

Preferably, the process of the present invention further comprises cooling the continuous tubular extrudate while said continuous tubular extrudate being hanged on and transferred by the plurality of horizontal posts.

Preferably, the extruding comprises pushing a mixture comprising vegetable protein and water to pass through an annular orifice. More preferably, said mixture comprises 100-150 parts by weight of soybean protein, 0-50 parts by weight of starch. 0-30 parts by weight of glycerol, 0-10 parts by weight of cooking oil, 80-100 parts by weight of water, and 0-10 parts by weight of fibrous material.

The present invention also discloses a transferring apparatus for preparing a vegetable casing comprising:

a looping means being able to be driven to rotate horizontally;

a driving means for driving the looping means to self-rotate;

a plurality of posts, each of which has one end pivotally connected to the looping means, so that the post is able to be rotated vertically with another end of the post not lower than the loop means;

a supporting beam disposed at one side of the looping means, wherein the supporting beam and the looping means form an imaginary horizontal plane;

an arcuate elevating rail with one end thereof located under the looping means, another end thereof connected to or above the supporting beam, and an arcuate section extending from the end upward to said another end and around the looping means,

wherein the another end of the post can move upward on the arcuate elevating rail and then horizontally on the supporting beam when the end of the post is carried by the looping means.

Preferably, the looping means comprises an endless chain or an endless belt.

Preferably, the driving means comprises a pair of wheels and a motor, wherein the wheels are engaged with the looping meaning, the looping means is supported by the wheels in the form of a loop, and one of the wheels is driven by the motor to rotate along a vertical axis, so that the looping means rotates horizontally.

Preferably, the plurality of posts are spaced at a constant interval.

Preferably, the transferring apparatus of the present invention further comprises a frame, wherein the driving means, the supporting beam and the arcuate elevating rail are disposed on the frame.

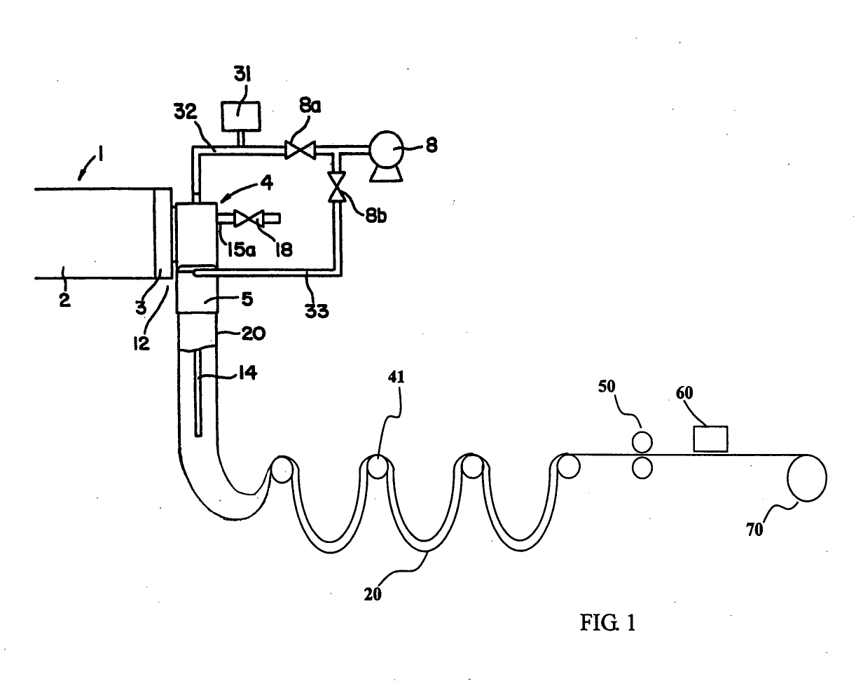

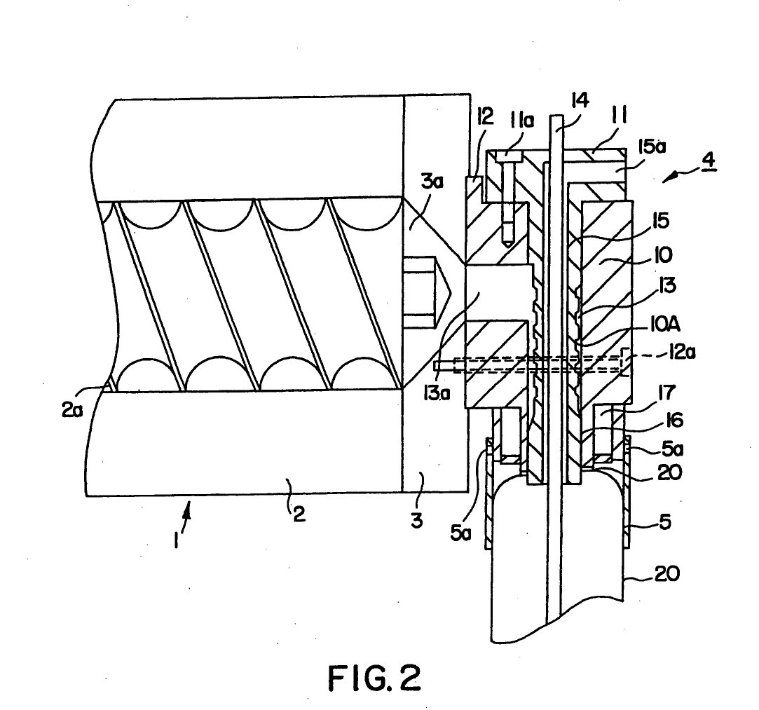

A suitable extruder suitable for use in the present invention is the one disclosed in U.S. Pat. No. 5,569,482. As shown in FIGS. 1 and 2, the extruder 1 is composed of the cylinder (barrel) 2 having the screw 2a and the die holder 3. The die 4 is fixed to the die holder 3.

The die 4 has the construction as shown by FIG. 2. That is, the flange part 12 of the hollow box 10 which constitutes the die 4 is fixed to the die holder 3 by the bolt 12a. The inlet opening 13a of the material pathway 13, which is provided in the hollow box 10 and has T-shaped form, is connected to the outlet opening 3a of the die holder 3. The tubular gas feeding pipe 14 and the cylinder 11 having the gas outflow pathway 15 which contains the gas feeding pipe 14 therein are provided to the material pathway 13.

The cylinder 11 is fixed in the hole 10A of the hollow box 10 by the bolt 11a. In the lower part of the cylinder 11, the circular opening 16 is formed at the lower position of the material pathway 13 of the hollow box 10.

The cooling jacket 17, which introduces gas as a cooling medium, is provided to the lower position of the outer periphery of the hollow box 10. The circular opening 16 is cooled by the cooling jacket 17.

A first flow controller 8a and optionally an anti-blocking agent feeder 31 are provided to a piping 32, which connects the gas feeding pipe 14 to a gas feeder 8 which is composed of a pump and the like. A second flow controller 8b is provided to a piping 33 which connects the cooling jacket 17 to the gas feeder 8. A outflow controller 18 is provided to a gas outlet 15a of the gas outflow pathway 15.

For producing the casing by using this apparatus, a melted raw material containing water and protein (not shown) is extruded from the extruder 1 and transferred to the material pathway 13 through the inlet 13a by pressure. The raw material containing water and protein is cooled during the transfer thereof through the material pathway 13 to a temperature at which no expansion occurs by the cooling jacket 17. The tubular extrudate 20 which is extruded downwards from the extruder opening 16 is received by a transferring apparatus provided below the die 4. The gas is fed continuously from the gas feeding pipe 14 to the interior of the tubular extrudate 20 by actuation of the gas feeder 8. The gas of higher pressure than the atmospheric pressure is fed into the tubular extrudate 20 after it is extruded from the circular opening 16. The gas which has been fed into the extrudate from the gas feeding pipe 14 flows oppositely toward the circular opening 16 of the die 4 in the tubular extrudate 20 and flows out through the gas outflow pathway 15 and the gas outlet 15a. During this stage, the gas dries the inner surface of the tubular extrudate 20 and is retained therein to stretch toward three-dimensional directions, while the tubular extrudate 20 is soft and not-solidified state just behind the circular opening 16 (FIGS. 1 and 2 show the state after stretching). In this stage, the stretch ratio is controlled by the amount and pressure of the gas introduced from the gas feeding pipe 14. The anti-blocking agent such as starch particles may be fed from the anti-blocking agent feeder 31 into the tubular extrudate 20 through the gas feeding pipe 14 to prevent adhesion of the inner walls of the extrudate.

Peripheral stretching of the tubular extrudate 20 which is stretched at about the circular opening outlet 16 of the die 4 is controlled by the tubular guide 5 fixed to the die 4 with the bolt 5a so that the tubular extrudate 20 having uniform perimeter can be obtained. The cylindrical extrudate 20 having different perimeters can be obtained by changing the perimeter of the inner cylinder of the cylindrical guide 5 and controlling the operation conditions of the extruder 1 and the conditions of gas feeding.

As shown in FIG. 1, the transferring apparatus of the present invention has a plurality of posts 41, and some of the posts 41 travel below the die 4 in horizontal for a distance at a constant speed, so that the continuous tubular extrudate 20 is hanged on the horizontal posts 41 and carried away from the die 4. A close space is formed in the hanged extrudate 20 between any two adjacent horizontal posts 41. The length of the hanged extrudate 20 between two adjacent horizontal posts 41 and the hanging time of the hanged extrudate 20 can be controlled by adjusting the speed of the posts 41 and/or the interval of two posts 41, that is the cooling time of the continuous tubular extrudate 20 can be controlled.

A pair of rollers 50 rotating in two opposite directions is used to grasp the continuous tubular extrudate 20 after it has been transferred a distance, wherein the speed of the continuous tubular extrudate 20 at the rollers 50 is substantially the same as the speed of the continuous tubular extrudate 20 exits the die 4. A cutter 60 is provided downstream of the rollers to cut the continuous tubular extrudate 20 into a thin film, which is then wound up on a collecting roller 70. The cutter 60 may be omitted and the continuous tubular extrudate 20 is wound up on the collecting roller 70 downstream the rollers 50.

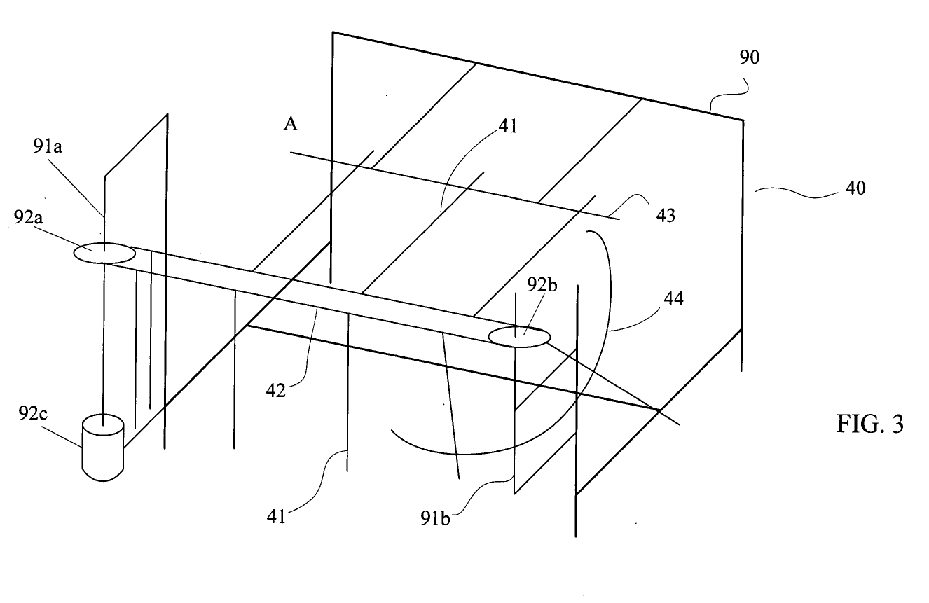

A transferring apparatus 40 suitable for use in FIG. 1 and constructed according to a preferred embodiment of the present invention is shown in FIG. 3. The transferring apparatus 40 has a frame 90; a pair of rotation spindles 91a and 91b mounted to the frame and at the outside of the frame; a driving mechanism comprising a pair of wheels 92a and 92b with their centers fixed on the rotation spindles 91a and 91b separately, and a motor 92c mounted on the frame 90 for rotating the spindle 91a; an endless chain 42 in the engagement with the wheels 92a and 92b in the form of a loop; a plurality of posts 41 with an equal interval between two adjacent posts, wherein one ends of the posts 41 are pivotally connected to the endless chain 42 and the posts 41 can be rotated vertically so that another ends thereof can be lifted upward to a height equal to or higher than the endless chain 42; a horizontal supporting beam 43 mounted on the frame 90 and inside the frame 90, wherein the supporting beam 43 is at the same height of the endless chain 42, so that the supporting beam 43 and the endless chain 42 form an imaginary horizontal plane; and an arcuate elevating rail 44 mounted on the frame 90 and outside the frame 90 with one end of the elevating rail 44 under the endless chain 42, another end of the elevating rail 44 slightly above the supporting beam 43, and an arcuate section extending from said one end upward to said another end and around the endless chain 42.

The endless chain 42 will be rotated counterclockwise through the help of the wheels 92a and 92b and the rotation spindles 91a and 91b, after the motor 92c is started. The posts 41 will be carried counterclockwise by the rotating endless chains 42, which are vertical due to gravity except those further supported by the elevating rail 44 and the supporting beam 43. The lower end of the post 41 is continuously lifted upward on the elevating rail 44 from the point when the post 41 contacts the elevating rail 44 until the lower end of the post 41 leaves the elevating rail 44. The lower end of the post 41 will be supported by the supporting beam 43 after leaving the elevating rail 44. The posts 41 with their another end supported by the supporting beams are now horizontal and carried below the die 4 (shown in FIG. 1) and away from the die 4 for a distance. The distance is from about the right end to the left end of the supporting beam 43. The posts 41 will be vertical again after their another ends leave the supporting beam 43. That is the another end of the post 41 will fall at the position A shown in FIG. 3 due to gravity. As the endless chain 42 rotates, some of the posts 41 will move horizontally for a distance from about the right end to the left end of the supporting beam 43 repeatedly. The continuous tubular extrudate 20 will be received on the horizontal posts 41 and transferred a distance before reaching the rollers 50 as shown in FIG. 1.

It is apparent that a loop conveyer having parallel horizontal posts can also be used in FIG. 1 to transfer the continuous tubular extrudate a distance, wherein the continuous tubular extrudate 20 is hanged on the parallel horizontal posts. The distance is the straight line portion of the loop conveyer.

### EXAMPLE

Dry raw materials were mixed prior to mixing with liquid raw materials, and the resulting pasty mixture was fed to an extruder to prepare a vegetable casing under the following conditions:

1. Raw materials: soybean protein isolate 30 wt %, wheat starch 20 wt %, glycerol 10 wt %, palm oil 5 wt % and water 35 wt %, wherein the soybean protein isolate and wheat starch were mixed, and then to the resulting mixture the glycerol, palm oil and water were added and stirred thoroughly.

2. The resulting pasty mixture was fed to a twin-screw extruder (Model: Tex58fc-20AW, The Japan Steel Work, LTD.) and extruded under the following conditions:
(1) Feeding speed: 25 rpm
(2) Temperature profiles of the cylinder: cooling/20/80/170-220/170-220/170-220° C.
(3) Rotation speed of the screws: 150-300 rpm
(4) Die temperature: 150-160° C.
(5) Die pressure: 5-40 kg/cm²
(6) Pressure of the compressed gas to expand the extrudate: 0.3-0.5 MPa

3. The tubular extrudate from the die was received by the transferring apparatus 40 shown in FIG. 3 at a rate of 450 cm/min. The interval between two adjacent posts 41 was 35 cm. The supporting beam 43 had a length of 30 cm. The speed of the posts 41 was 450 cm/min. The tubular extrudate 20 was hanged on and carried by the horizontal posts 41 with a close space inside the tubular extrudate 20 between two adjacent horizontal posts 41 as shown in FIG. 1.

The tubular extrudate 20 transferred by the transferring apparatus 40 for a distance was examined, and substantially no adhering occurred inside the tubular extrudate 20.

In another example of the present invention the dry raw materials and the liquid materials were fed to the extruder directly, where they were mixed and extruded. In further another example of the present invention, the liquid raw materials were simplified and only water was used as the liquid raw material.

1. A process for preparing vegetable casing comprising the following steps:
a) extruding a continuous tubular extrudate; and
b) transferring the continuous tubular extrudate;
wherein said transferring comprises repeatedly and horizontally moving a plurality of spaced horizontal posts at a constant speed below the continuous tubular extrudate; hanging the continuous tubular extrudate on the plurality of horizontal posts to transfer the continuous tubular extrudate a distance, wherein a closed space is formed in the continuous tubular extrudate hanged between two adjacent horizontal posts.

2. The process of claim 1, wherein the plurality of horizontal posts are moved at a speed equal to or lower than the extruding speed of the continuous tubular extrudate.

3. The process of claim 1, wherein the plurality of horizontal posts are spaced at a constant interval.

4. The process of claim 1 further comprising cutting the continuous tubular extrudate into a continuous film after said continuous tubular extrudate being transferred a distance.

5. The process of claim 1 further comprising collecting the continuous tubular extrudate after said continuous tubular extrudate being transferred a distance.

6. The process of claim 1 further comprising cooling the continuous tubular extrudate while said continuous tubular extrudate being hanged on and transferred by the plurality of horizontal posts.

7. The process of claim 1, wherein the extruding comprises pushing a mixture comprising vegetable protein and water to pass through an annular orifice.

8. The process of claim 7, wherein said mixture comprises 100-150 parts by weight of soybean protein, 0-50 parts by weight of starch. 0-30 parts by weight of glycerol, 0-10 parts by weight of cooking oil, 80-100 parts by weight of water, and 0-10 parts by weight of fibrous material.

9. A transferring apparatus for preparing a vegetable casing comprising:
a looping means being able to be driven to rotate horizontally;
a driving means for driving the looping means to self-rotate;
a plurality of posts, each of which has one end pivotally connected to the looping means, so that the post is able to be rotated vertically with another end of the post not lower than the loop means;
a supporting beam disposed at one side of the looping means, wherein the supporting beam and the looping means form an imaginary horizontal plane;
an arcuate elevating rail with one end thereof located under the looping means, another end thereof connected to or above the supporting beam, and an arcuate section extending from the end upward to said another end and around the looping means,
wherein the another end of the post can move upward on the arcuate elevating rail and then horizontally on the supporting beam when the end of the post is carried by the looping means.

10. The transferring apparatus of claim 9, wherein the looping means comprises an endless chain or an endless belt.

11. The transferring apparatus of claim 9, wherein the driving means comprises a pair of wheels and a motor, wherein the wheels are engaged with the looping meaning, the looping means is supported by the wheels in the form of a loop, and one of the wheels is driven by the motor to rotate along a vertical axis, so that the looping means rotates horizontally.

12. The transferring apparatus of claim 9, wherein the plurality of posts are spaced at a constant interval.

13. The transferring apparatus of claim 9 further comprising a frame, wherein the driving means, the supporting beam and the arcuate elevating rail are disposed on the frame.
